(19) United States
(12) Patent Application Publication
(10) Pub. No.: US 2023/0330460 A1
(43) Pub. Date: Oct. 19, 2023

(54) SYSTEMS FOR FIRE SUPPRESSION WITH ENCAPSULATED SUPPRESSANT AGENT

(71) Applicant: Tyco Fire Products LP, Cranston, RI (US)

(72) Inventor: Ben Markovitz, Howard, WI (US)

(73) Assignee: Tyco Fire Products LP, Cranston, RI (US)

(21) Appl. No.: 18/295,118

(22) Filed: Apr. 3, 2023

Related U.S. Application Data
(60) Provisional application No. 63/331,673, filed on Apr. 15, 2022.

(51) Int. Cl. A62C 3/07; A62C 35/11; A62C 5/02

(52) U.S. Cl. CPC A62C 3/07; A62C 35/11; A62C 5/02

(57) ABSTRACT

A system for providing fire suppression includes multiple capsules and a suppression system. The capsules may be positioned proximate a hazard. Each capsule includes a wall configured to rupture in response to a particular temperature or in response to fluidic contact. The capsules are each configured to store a suppressant agent within the wall of the capsule. The suppression system is configured to discharge a fluid to the hazard in response to a thermal condition at the hazard. The fluid is configured to react with the suppressant agent to provide fire suppression to the hazard.

### CROSS-REFERENCE TO RELATED PATENT APPLICATION

This application claims the benefit of and priority to U.S. Provisional Application No. 63/331,673, filed Apr. 15, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

One implementation of the present disclosure is a system for providing fire suppression, according to some embodiments. The system includes multiple capsules and a suppression system. The capsules may be positioned proximate a hazard. Each capsule includes a wall configured to rupture in response to a condition. The capsules are each configured to store a suppressant agent within the wall of the capsule. The suppression system is configured to discharge a fluid to the hazard in response to a thermal condition at the hazard. The fluid is configured to react with the suppressant agent to provide fire suppression to the hazard.

In some embodiments, the hazard is a battery cell, an electric motor, or an internal combustion engine. The capsules may be configured to rupture to release the suppressant agent to the hazard to suppress a fire at the hazard in response to a temperature at the wall reaching the particular temperature or in response to fluidic contact with a particular fluid. In some embodiments, the condition includes the wall reaching a particular temperature, the wall contacting a particular fluid, or a presence of a particular gas at the wall.

The suppressant agent may be a dry or a gelled additive. The fluid and the suppressant agent can mix and foam to provide the fire suppression.

The capsules may have a pill shape or a spherical shape and encapsulate a discrete amount of the suppressant agent. The capsules may be positioned above the hazard such that the suppressant agent falls onto the hazard when the wall ruptures.

The capsules may be first capsules the suppressant agent is a first type of suppressant agent. The system can further second capsules positioned proximate the hazard. The second capsules each include a wall configured to rupture in response to the particular temperature or in response to fluidic contact, and configured to store a second type of suppressant agent within the wall of the capsule. The first capsules and the second capsules can be positioned proximate each other and proximate the hazard such that the first suppressant agent and the second suppressant agent are configured to discharge onto the hazard when the temperature at first capsules and the second capsules reaches the particular temperature.

Another implementation of the present disclosure is a container system, according to some embodiments. The container system include a container, and multiple capsules. The container defines an inner volume. Multiple modules are positioned within the inner volume. The modules include multiple battery cells. The capsules are positioned proximate the battery cells. Each capsule includes a wall configured to rupture in response to reaching a particular temperature, and is configured to store a suppressant agent within the wall of the capsule. The capsules are configured to provide the suppressant agent to the plurality of battery cells when the wall ruptures.

The wall of the capsules may be configured to rupture in response to fluidic contact. The container system may further include a suppression system configured to discharge a fluid to the battery cells in response to a thermal condition at the hazard, wherein the fluid is configured to react with the suppressant agent to provide fire suppression to the plurality of battery cells.

The suppressant agent may include a dry or a gelled additive. The fluid and the suppressant agent can mix and foam to provide the fire suppression.

The capsules have a pill shape or a spherical shape and encapsulate a discrete amount of the suppressant agent. The container may include multiple packs. Each pack may include multiple subpacks positioned within the pack. Each subpack may include multiple modules positioned within the subpack. Each module may include a subset of the plurality of battery cells positioned within the module.

The capsules may be first capsules positioned within the modules proximate the battery cells. The container system may further include second capsules positioned within the subpacks, and a third capsules positioned within the packs. The first capsules, the second capsules, and the third capsules can each include a first subset of capsules configured to store and discharge a first type of suppressant agent, and a second subset of capsules configured to store and discharge a second type of suppressant agent.

Another implementation of the present disclosure is a vehicle, according to some embodiments. The vehicle may include a chassis, tractive elements coupled with the chassis, a pack, multiple capsules, and a suppressions system. The pack may be disposed on the chassis. The pack includes multiple of battery cells. The capsules are positioned proximate the battery cells. Each capsule includes a wall that is configured to rupture in response to a particular temperature or in response to fluidic contact, and configured to store a suppressant agent within the wall of the capsule. The suppression system is configured to discharge a fluid into the pack in response to a thermal condition at the battery cells. The fluid is configured to react with the suppressant agent to provide fire suppression to the battery cells.

The capsules may be configured to rupture to release the suppressant agent to the battery cells to suppress a fire at the pack in response to a temperature at the wall reaching the particular temperature or in response to fluidic contact with a particular fluid. The suppressant agent may include a dry or a gelled additive. The fluid and the suppressant agent can mix and foam to provide the fire suppression.

The capsules may be first capsules and the suppressant agent may be a first type of suppressant agent. The vehicle can further include second capsules positioned proximate the battery cells. The second capsules each include a wall configured to rupture in response to the particular temperature or in response to fluidic contact. The second capsules are configured to store a second type of suppressant agent within the wall of the capsule.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a diagram of a pack of the battery system of FIG. 1 including one or more capsules of suppressant agent within the pack, according to an exemplary embodiment.

FIG. 6 is a diagram of a capsule of suppressant agent, according to an exemplary embodiment.

FIG. 7 is another diagram of a capsule of suppressant agent, according to an exemplary embodiment.

FIG. 8 is a left side view of a vehicle utilizing the battery system of FIG. 1 with multiple capsules of suppressant agent positioned above the pack, according to an exemplary embodiment.

FIG. 9 is a left side view of a vehicle utilizing the battery system of FIG. 1 with multiple capsules of suppressant agent positioned on a ceiling above the pack, according to an exemplary embodiment.

FIG. 10 is another diagram of a pack of the battery system of FIG. 1 including one or more capsules of suppressant agent within the pack, according to an exemplary embodiment.

FIG. 11 is a diagram of an array of the capsules of suppressant agent of FIGS. 6 and 7 including two types of capsules, according to an exemplary embodiment.

FIG. 12 is a diagram of a pack of the battery system of FIG. 1 including one or more blocks of suppressant agent within the pack, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems include encapsulating dry or gelled fire suppression agent within a water or thermally labile casing for aqueous application at a site of a hazard. The casing may have the form of pills, capsules, pouches and/or bags which can be located either on hazard or near premix site. The agent within the capsules may be solubilized with water applied before or during fire suppression from hose, sprinkler, pipe or other discharge device.

Firefighting agents can absorb water thus changing the potency and amount required for successful fire suppression. Premixed agents can add cost to the consumer due to added shipping weight and less available agent per purchase. In some embodiments, solid agents mixed with water applied on scene of the thermal event allows for greater agent quantity to be delivered more cost-effectively.

Locating the solid agent near potential or predicted sites of thermal events may minimize loss by reducing the time between event and agent discharge. In some embodiments, the systems described herein are applicable to multiple hazard types including batteries.

In some embodiments, the systems include solid agent without encapsulation. In some embodiments, different agent dispersion solidification techniques including spray drying or recrystallization. In some embodiments, the systems include larger solid quantities (e.g., briquettes) which are processed (e.g., through grinding) on site before combining with water or application to the hazard.

### System Overview

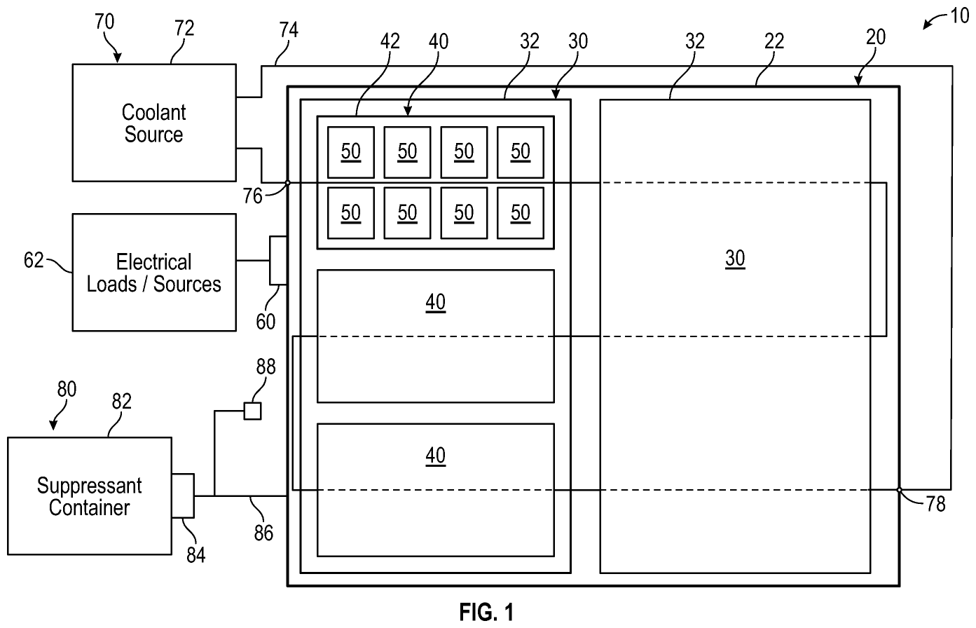

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

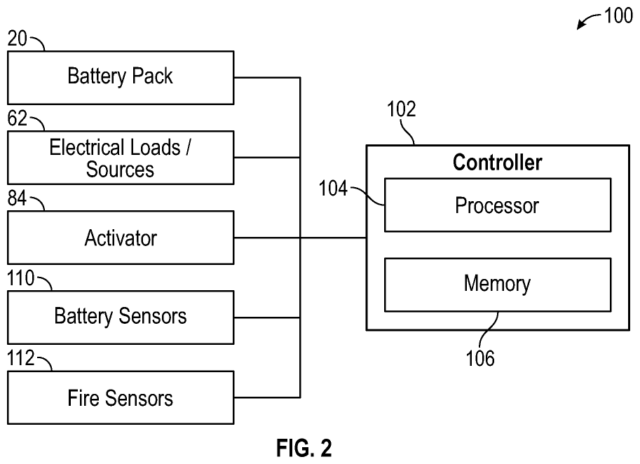

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

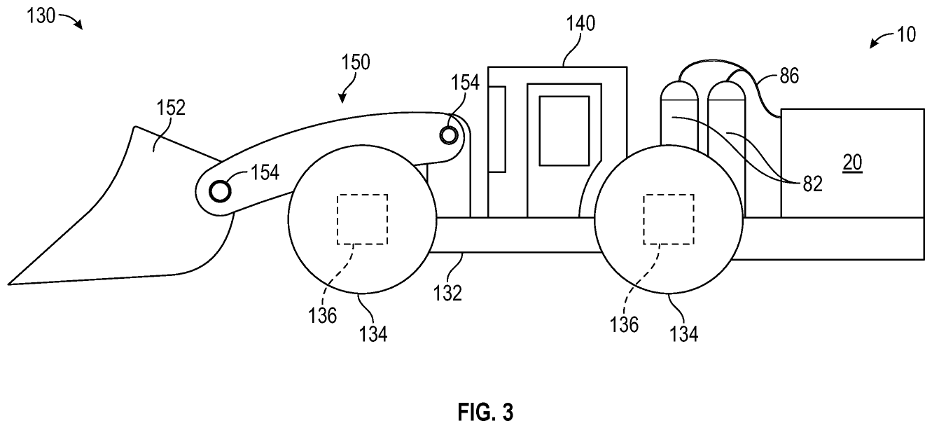

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

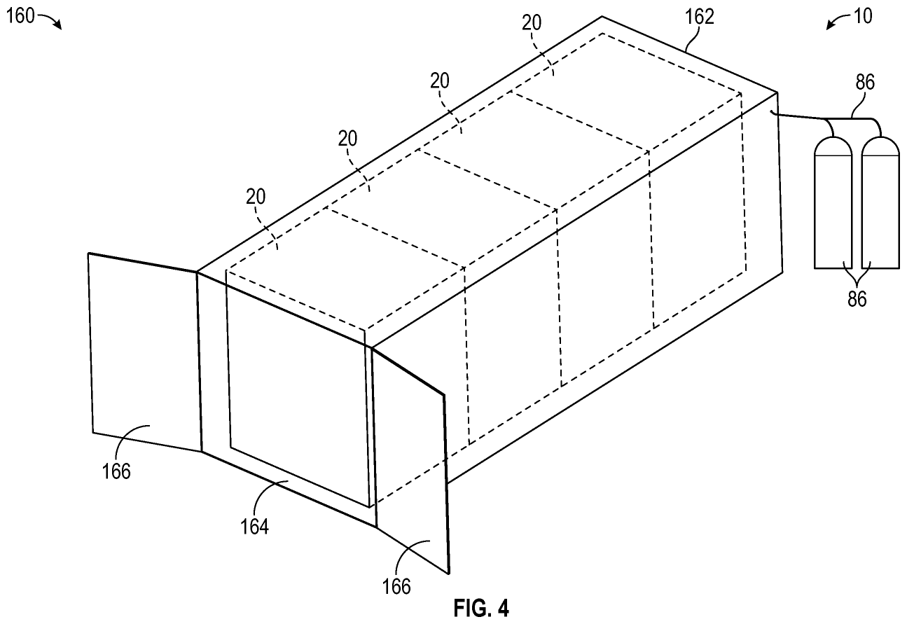

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Encapsulated Suppressant Agent

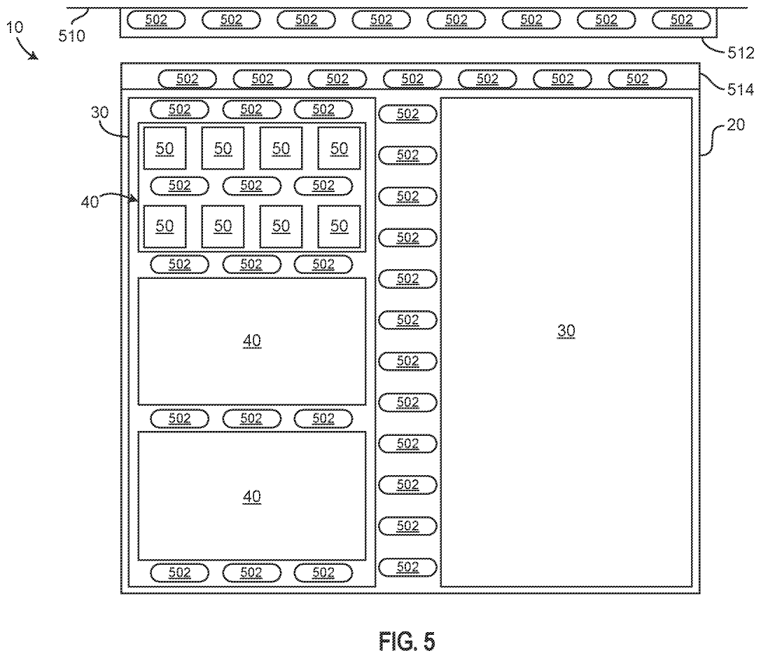

Referring to FIGS. 5-10, the system 10 can include or be configured for use with one or more capsules 502 of suppressant agent (e.g., dry agent or suppressant, gelled agent or suppressant, liquid agent or suppressant, etc.). The capsules 502 of suppressant can be thermally labile or aqueously labile so that walls of the capsules 502 rupture or open in response to being in contact with a liquid (e.g., water) or in response to heat transfer to the walls of the capsules 502 (e.g., in response to a temperature exceeding a threshold, exceeding a rate of change, etc.). Once the capsules 502 rupture or open, the suppressant agent exits, discharges, is dispensed, etc., from the capsules 502 to provide fire suppression to a hazard (e.g., to nearby areas where the capsules 502 are positioned).

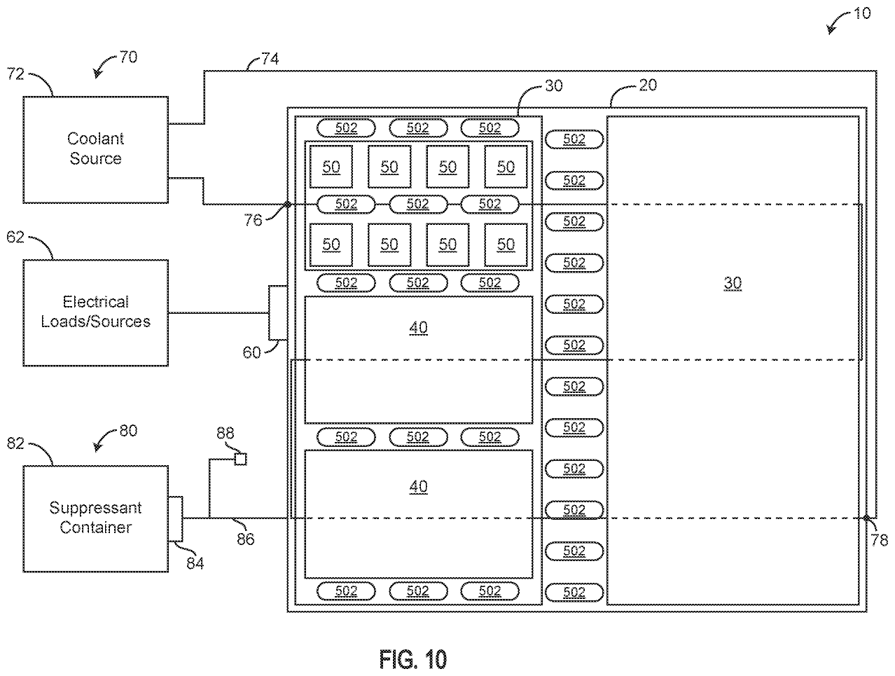

Referring particularly to FIGS. 5 and 10, the battery pack 20 may include capsules 502 positioned within the battery pack 20 (e.g., within the pack housing 22). In some embodiments, the capsules 502 are positioned within the pack housing 22 of the battery pack 20, proximate subpacks 30 (e.g., between adjacent subpacks 30, beneath subpacks 30, on top of subpacks 30, along the sides of the subpacks 30, etc.) so that the capsules 502 provide suppressant agent to the subpacks 30. In some embodiments, the capsules 502 are positioned within the subpacks 30 (e.g., within the housings 32) proximate the battery modules 40. For example, the capsules 502 can be positioned along sides of the battery modules 40, on top of the battery modules 40, along sides of the battery modules 40, etc., to provide suppressant agent to the battery modules 40 when the capsules 502 rupture or open.

Referring still to FIGS. 5 and 10, the capsules 502 can be positioned within the battery modules 40 (e.g., within the housing 42 of the battery modules 40 proximate the battery cells 50) so that when the capsules 502 rupture or open, the suppressant agent is discharged to, dispensed onto, etc., the battery cells 50. The capsules 502 can be positioned on top of the battery cells 50, along sides of the battery cells 50, mounted to an inner wall of the housing 42 of the battery modules 40, mounted to a ceiling inside the housing 42, etc.

Referring still to FIGS. 5 and 10, one or more capsules 502 can be positioned externally to the pack 20. For example, one or more capsules 502 can be positioned along a ceiling 510 that is above the pack 20. In some embodiments, the one or more capsules 502 positioned along the ceiling 510 are supported by a structure 512 (e.g., a frame, a rail, an assembly, a holder) that is coupled with the ceiling 510 (e.g., fastened) and holds the capsules 502 in place (e.g., a distance above a top of the pack 20). In some embodiments, one or more capsules 502 are positioned externally to the pack 20 (e.g., externally to the pack housing 22) on top of the pack 20. For example, the one or more capsules 502 can be positioned on top of the pack 20 within a structure 514 (e.g., a housing, an external pack, etc.). In some embodiments, one or more capsules 502 are positioned along sides of the pack 20 on an external wall of the housing 22 of the pack 20. In some embodiments, one or more capsules 502 are positioned within the pack 20 (e.g., within the housing 22 of the pack 20) along a ceiling of the pack 20.

In some embodiments, one or more, or all of the capsules 502 as shown in FIGS. 5 and 10 are thermally responsive capsules 502. For example, the pack 20 as shown in FIG. 5 may be configured for use with any of the cooling system 70 and the coolant source 72, the electrical loads/sources 62, the suppression system 80 and suppressant container 82, etc., as shown in FIG. 1. In some embodiments, the capsules 502 as shown in FIG. 5 have a thermally labile wall or are manufactured from a thermally labile material so that operation of the cooling system 70, the electrical loads/sources 62, the suppression system 80, etc., are not required in order for the capsules 502 to break open and release suppressant agent. In some embodiments, the capsules 502 are responsive to temperature or heat so that when a fire event occurs or begins to occur at the battery cells 50, at the battery modules 40, at the subpacks 30, at the pack 20, etc., the capsules 502 release suppressant agent. Advantageously, only capsules 502 that are proximate an area where an elevated temperature or heat transfer occurs may rupture, thereby resulting in localized and targeted application of suppressant or agent.

Referring particularly to FIG. 10, a fluid can be provided into the pack 20 in response to the capsules 502 opening and releasing the suppressant agent. In some embodiments, the fluid is provided by operation of the suppressant container 82 (e.g., by operation of the suppression system 80) to provide a liquid or fluid suppressant into the pack 20, into the subpacks 30, into the battery modules 40, etc. In some embodiments, the liquid or fluid is configured to react with the agent that is released by the capsules 502, to thereby provide fire suppression for the pack 20 or components of the pack 20. In some embodiments, the discharge of liquid or fluid into the pack 20 by operating the suppression system 80 results in the capsules 502 bursting or breaking, to discharge the suppressant agent. In some embodiments, the suppressant that is stored in the suppressant container 82 does not include the suppressant agent that is contained in the capsules 502. In other systems, a liquid and the suppressant agent are mixed to result in a particular type of suppressant agent (e.g., a foam) for fire suppression, the mixed agent being stored within the suppressant container 82. However, in the embodiment shown in FIGS. 5 and 10, the fluid stored in the suppressant container 82 stores liquid or a pre-mix portion of suppressant that does not include the suppressant agent that is contained in the capsules 502. The liquid or the pre-mix portion of the suppressant that is contained in the suppressant container 82 is discharged into the pack 20 and mixes with (e.g., reacts with) the suppressant agent of the capsules 502 within the pack 20, within the subpack 30, within the modules 40, or more generally, within the shipping container 162, to provide improved fire suppression. The suppression system 80 may operate to discharge the suppressant into the shipping container 162, the pack 20, the subpack 30, or the battery modules 40 in response to detected temperature, a rate of change of detected temperature, in response to the detection of an off-gas emitted by the battery cells 50, in response to detection of a thermal event or thermal runaway, etc.

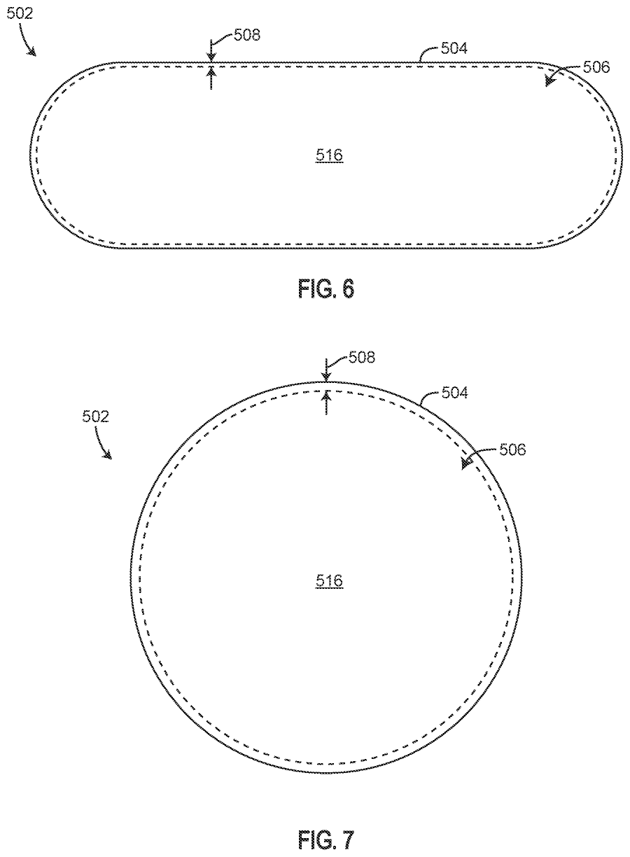

Referring to FIGS. 6 and 7, various embodiments of the capsules 502 are shown. As shown in FIGS. 6 and 7, the capsules 502 can have the form of a pill-shaped capsule, or a spherical capsule. In some embodiments, the capsules 502 have the form of a bag, a pouch, etc. The capsules 502 include a sidewall 504 (e.g., a wall, a membrane, etc.) having a thickness 508. The capsules 502 define an inner volume 506 within which suppressant agent 516 is stored. In some embodiments, the sidewalls 504 are manufactured from a polymer or a metal foil. In some embodiments, the thickness 508 and the material of the sidewalls 504 are configured so that the sidewalls 504 rupture when a specific temperature is reached, when a certain amount of liquid suppressant agent is supplied, when the sidewalls 504 contact acid, in response to contact with a vapor or fluid, etc.

In some embodiments, the suppressant agent 516 encapsulated by the sidewalls 504 is a dry or gelled agent that is configured to mix with water to result in fire suppressant (e.g., to foam, to react with each other, etc.). For example, the suppressant agent 516 may have a powder form, and may chemically react with water. The temperature or water may cause the sidewalls 504 to rupture, dissolve, open, etc., thereby releasing the suppressant agent 516.

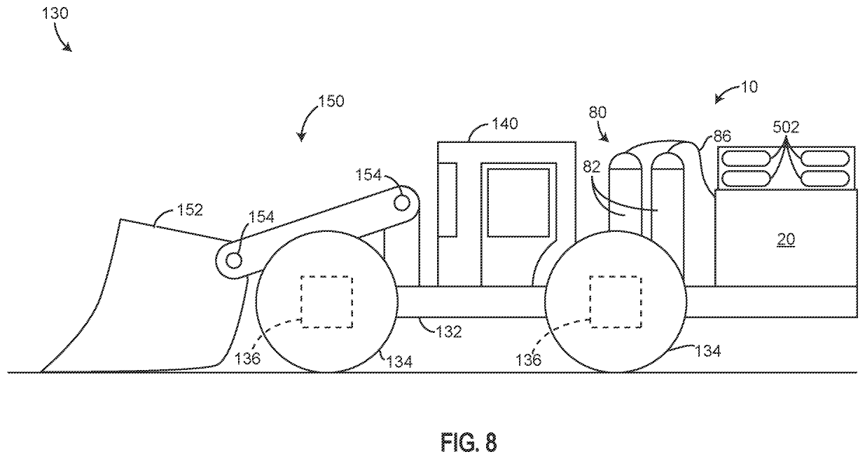

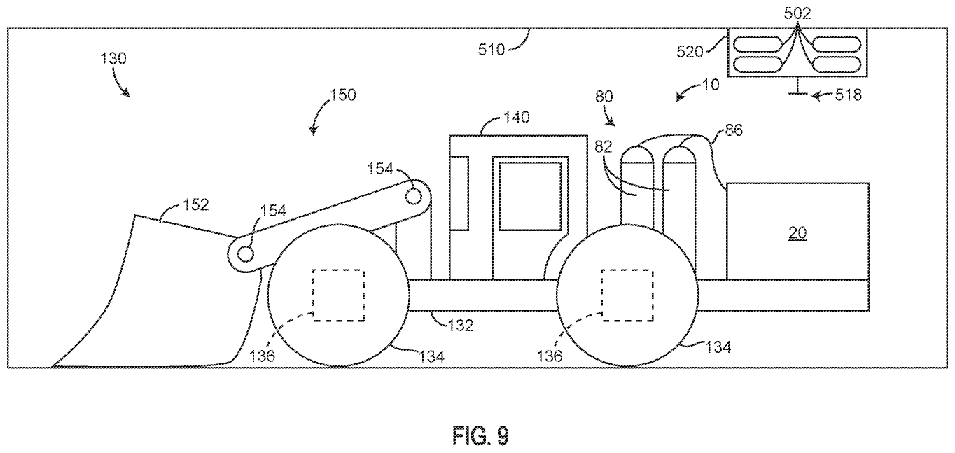

Referring to FIGS. 8 and 9, the capsules 502 can be used to provide fire suppression for the vehicle 130. Referring to FIG. 8, in some embodiments, the capsules 502 are positioned on top of or within the pack 20 of the vehicle 130. When temperature exceeds a threshold amount at one or more of the capsules 502, or when water or a fluidic suppressant is added to the pack 20, the heat or the liquid may cause the capsules 502 to rupture, thereby releasing the suppressant agent 516. If the capsules 502 rupture in response to heat, then water, fluid, a gas (e.g., an off-gas, an electrolytic gas, etc.), a liquid, etc., can be provided to the pack 20 subsequently (e.g., by operating the suppressions system 80) so that the suppressant agent 516 mixes with the suppressant or fluid provided by the suppression system 80 to provide fire suppression for the pack 20 (e.g., to provide foaming). If the capsules 502 rupture in response to fluidic contact and not in response to heat, the capsules 502 may rupture and release the suppressant agent 516 when the suppression system 80 operates to discharge the suppressant into the pack 20. In some embodiments, the capsules 502 rupture in response to a presence of a gas (e.g., electrolyte gases), such as a lithium-ion battery off-gas, carbon dioxide, carbon monoxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible gases, flammable gases, toxic gases, corrosive gases, oxidizing gases, an electrolyte vapor, etc.

Referring particularly to FIG. 9, the capsules 502 may be mounted on the ceiling 510 (e.g., in a storage bay, a garage, etc.) above the pack 20. When the pack 20 undergoes a thermal event and heats up, the heat may rise and be transferred to the capsules 502, thereby causing the capsules 502 to burst, and release the suppressant agent 516 onto the pack 20. In some embodiments, a sprinkler 518 on the ceiling 510 or on a structure 520 of the ceiling 510 is configured to operate after the capsules 502 burst (or after a temperature exceeds a threshold amount) to provide fluid (e.g., water) onto the pack 20 to react with the suppressant agent 516 to provide fire suppression for the pack 20. In some embodiments, the sprinkler 518 is operated in response to temperature, in response to detected rupture of the capsules 502, etc. In some embodiments, the capsules 502 are mounted on a ceiling of a charging station (e.g., a charging station for charging the pack 20).

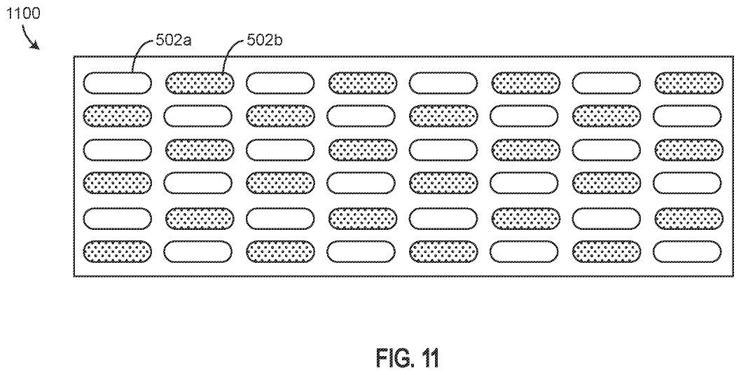

Referring to FIG. 11, a diagram 1100 illustrates an array of capsules 502 including first capsules 502a and second capsules 502b. The first capsules 502a include the suppressant agent 516 as described in greater detail above with reference to FIGS. 6 and 7, and are configured to release the suppressant agent 516 when the sidewalls 504 of the first capsules 502a break. The second capsules 502b include a liquid or a fluid that is configured to be released when the sidewalls 504 of the second capsules 502b break. In some embodiments, the first capsules 502a and the second capsules 502b are substantially similar, but contain different substances. In some embodiments, the suppressant agent 516 is an additive (e.g., a dry or a gelled additive) that is configured to mix with the liquid within the second capsules 502b when the first capsules 502a and the second capsules 502b break open, thereby releasing the suppressant agent 516 and the liquid or fluid. The suppressant agent 516 and the liquid or fluid may mix, undergo foaming, and suppress a fire or thermal event. It should be understood that any of the shipping container 162, the packs 20, the subpacks 30, the battery modules 40, as described in greater detail above with reference to FIGS. 1-5 and 8-10 may include a combination of both the first capsules 502a and the second capsules 502b, thereby removing the need to introduce fluid from an external system (e.g., the suppression system 80). In some embodiments, the second capsules 502b and the first capsules 502a have different sizes so that an appropriate relative amount of the suppressant agent 516 and the fluid is provided for fire suppression. In some embodiments, the second capsules 502b and the first capsules 502a are configured (e.g., with their wall thicknesses) to break at a same temperature. In some embodiments, the wall thickness of the second capsules 502b is slightly thicker than the thickness of the walls of the first capsules 502a so that the first capsules 502a break and release the suppressant agent 516 before the walls of the second capsules 502b break to release the liquid.

Referring still to FIG. 11, in some embodiments, any of the capsules 502 described herein include both the suppressant agent 516 mixed with a liquid. In this way, the capsules 502 can break to provide fully mixed suppressant, without requiring further mixing.

Advantageously, the systems described herein provide localized application of suppressant agent via locally positioned capsules that break in response to a thermal event or in response to contact with a fluid. The suppressant agent may require mixing with a liquid or fluid to provide appropriate fire suppression. The liquid or fluid can be manually discharged to mix with the suppressant agent, or can be positioned in other capsules that are located proximate the capsules that contain the suppressant agent. The systems described herein advantageously locate the suppressant agent 516 proximate a hazard site (e.g., a site there a thermal event may occur) to reduce an amount of time between the event occurring and application of fire suppression.

It should be understood that while the systems described herein are shown providing fire suppression for a battery system, the systems described herein can be applicable for other devices or systems. For example, the capsules 502 can be applicable for a kitchen system, a welding station, etc.

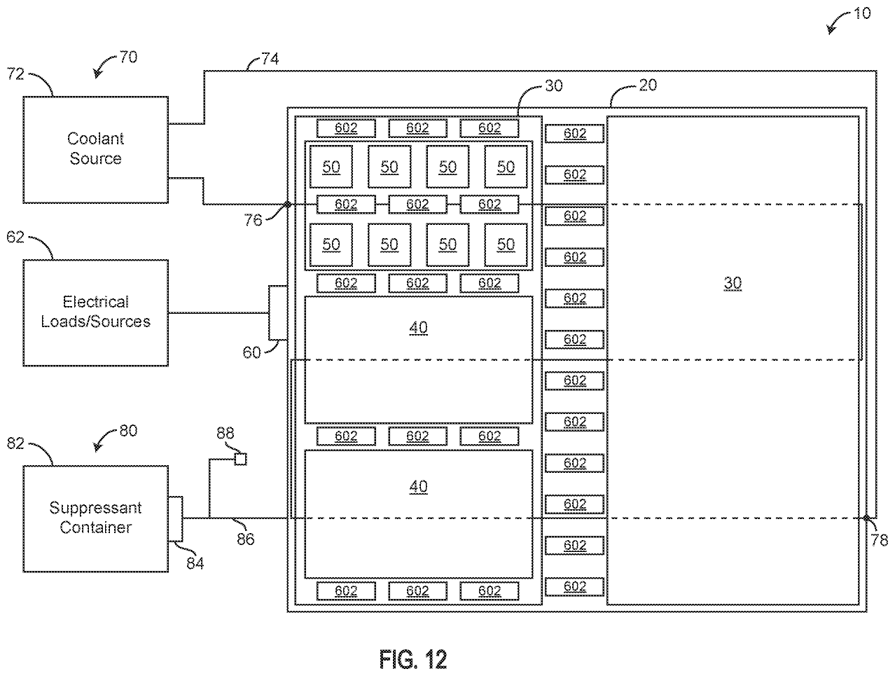

Referring to FIG. 12, an alternative embodiment of the embodiment shown in FIGS. 5 and 10 and described in greater detail above includes multiple blocks 602 of solid agent (e.g., compacted solid agent, briquettes, etc.) that are positioned in place of the capsules 502. In some embodiments, the blocks 602 are a solid or compacted or structurally self-contained form of the suppressant agent 516 that is positioned within the capsules 502. In some embodiments, the blocks 602 of suppressant agent are configured to react, mix, or otherwise interact with water or fluid that is added to the pack 20.

Referring to FIGS. 5, 8-9, 10, and 12, one or more surfaces of the pack 20, the subpacks 30, the battery modules 40, or the battery modules 50 can be covered with a coating of the dry or solid form of the suppressant agent 516. The suppressant agent 516 can be spray dried onto the surfaces, or recrystallized on the surfaces. In some embodiments, the suppression system 80 is configured to provide a fluid (e.g., water) that reacts with the coatings of the suppressant agent 516, the blocks 602 of the suppressant agent 516, or otherwise reacts with, mixes with, foams with, etc., the suppressant agent 516.

Referring to FIGS. 5-12, in some embodiments, solid quantities of the suppressant agent 516 are processed on-site (e.g., ground) before being combined with water and applied to the hazard (e.g., discharged by the suppression system 80 into the pack 20, the subpacks 30, the battery modules 40, etc.). Advantageously, processing and mixing the suppressant agent 516 on-site can improve fire suppression abilities of the mixed water and suppressant agent 516. The suppression system 80 can include a reserve of dry, powder, or solid form of the suppressant agent 516 that is added to the water or fluid as the fluid is discharged to the hazard (e.g., to the battery cells 50).

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for providing fire suppression, the system comprising:
a plurality of capsules positioned proximate a hazard, each capsule comprising a wall configured to rupture in response to a condition, and configured to store a suppressant agent within the wall of the capsule; and
a suppression system configured to discharge a fluid to the hazard in response to a thermal condition at the hazard, wherein the fluid is configured to react with the suppressant agent to provide the fire suppression to the hazard.

2. The system of claim 1, wherein the hazard comprises a battery cell, an electric motor, or an internal combustion engine.

3. The system of claim 1, wherein the condition comprises the wall reaching a particular temperature, the wall contacting a particular fluid, or a presence of a particular gas at the wall.

4. The system of claim 1, wherein the suppressant agent comprises a dry or a gelled additive, wherein the fluid and the suppressant agent mix and foam to provide the fire suppression.

5. The system of claim 1, wherein the plurality of capsules have a pill shape or a spherical shape and encapsulate a discrete amount of the suppressant agent.

6. The system of claim 1, wherein the plurality of capsules are positioned above the hazard such that the suppressant agent falls onto the hazard when the wall ruptures.

7. The system of claim 1, wherein the plurality of capsules are a first plurality of capsules and the suppressant agent is a first type of suppressant agent, wherein the system further comprises a second plurality of capsules positioned proximate the hazard, the second plurality of capsules each comprising a wall configured to rupture in response to the condition, and configured to store a second type of suppressant agent within the wall of the capsule.

8. The system of claim 7, wherein the first plurality of capsules and the second plurality of capsules are positioned proximate each other and proximate the hazard such that the first type of suppressant agent and the second type of suppressant agent are configured to discharge onto the hazard when a temperature at the first plurality of capsules and the second plurality of capsules reaches a particular temperature.

9. A container system comprising:
a container defining an inner volume, a plurality of modules positioned within the inner volume, the plurality of modules comprising a plurality of battery cells; and
a plurality of capsules positioned proximate the plurality of battery cells, each capsule comprising a wall configured to rupture in response to reaching a particular temperature, and configured to store a suppressant agent within the wall of the capsule, wherein the plurality of capsules are configured to provide the suppressant agent to the plurality of battery cells when the wall ruptures.

10. The container system of claim 9, wherein the wall of each of the plurality of capsules is further configured to rupture in response to fluidic contact.

11. The container system of claim 9, further comprising a suppression system configured to discharge a fluid to the plurality of battery cells in response to a thermal condition at the plurality of battery cells, wherein the fluid is configured to react with the suppressant agent to provide fire suppression to the plurality of battery cells.

12. The container system of claim 11, wherein the suppressant agent comprises a dry or a gelled additive, wherein the fluid and the suppressant agent mix and foam to provide the fire suppression.

13. The container system of claim 9, wherein the plurality of capsules have a pill shape or a spherical shape and encapsulate a discrete amount of the suppressant agent.

14. The container system of claim 9, wherein the container comprises a plurality of packs, each pack of the plurality of packs comprising a plurality of subpacks positioned within the pack, each subpack of the plurality of subpacks comprising a plurality of modules positioned within the subpack, and each module of the plurality of modules comprising a subset of the plurality of battery cells positioned within the module.

15. The container system of claim 14, wherein the plurality of capsules is a first plurality of capsules positioned within the plurality of modules proximate the plurality of battery cells, the container system further comprising a second plurality of capsules positioned within the plurality of subpacks, and a third plurality of capsules positioned within the plurality of packs.

16. The container system of claim 15, wherein the first plurality of capsules, the second plurality of capsules, and the third plurality of capsules each include a first subset of capsules configured to store and discharge a first type of suppressant agent, and a second subset of capsules configured to store and discharge a second type of suppressant agent.

17. A vehicle comprising:
a chassis;
a plurality of tractive elements coupled with the chassis;
a pack disposed on the chassis, the pack comprising a plurality of battery cells;
a plurality of capsules positioned proximate the plurality of battery cells, each capsule comprising a wall configured to rupture in response to a particular temperature or in response to fluidic contact, and configured to store a suppressant agent within the wall of the capsule; and
a suppression system configured to discharge a fluid into the pack in response to a thermal condition at the plurality of battery cells, wherein the fluid is configured to react with the suppressant agent to provide fire suppression to the plurality of battery cells.

18. The vehicle of claim 17, wherein the plurality of capsules are configured to rupture to release the suppressant agent to the plurality of battery cells to suppress a fire at the pack in response to a temperature at the wall reaching the particular temperature or in response to fluidic contact with a particular fluid.

19. The vehicle of claim 17, wherein the suppressant agent comprises a dry or a gelled additive, wherein the fluid and the suppressant agent mix and foam to provide the fire suppression.

20. The vehicle of claim 17, wherein the plurality of capsules are a first plurality of capsules and the suppressant agent is a first type of suppressant agent, wherein the vehicle further comprises a second plurality of capsules positioned proximate the plurality of battery cells, the second plurality of capsules each comprising a wall configured to rupture in response to the particular temperature or in response to fluidic contact, and configured to store a second type of suppressant agent within the wall of the capsule.
